(19) United States
(12) Patent Application Publication
(10) Pub. No.: US 2006/0070197 A1
(43) Pub. Date: Apr. 6, 2006

(54) Hand held cleaning utensil

(76) Inventors: Andy Robert May, London (GB); Daniel Neumann, London (GB)

Correspondence Address: Bradley N. Ruben, Suite 5A, 463 First St, Hoboken, NJ, 07030, US

(21) Appl. No.: 10/535,594

(22) PCT Filed: Sep. 19, 2003
(86) PCT No.: PCT/GB03/04147

§ 371 Date: May 19, 2005

(30) Foreign Application Priority Data
Nov. 28, 2002 (GB) 0227796.0

(51) Int. Cl. A46B 5/00; A47L 13/42; B25G 1/00

(52) U.S. Cl. 15/144.1; 15/144.3

(57) ABSTRACT

The present invention provides a hand held cleaning utensil having an extendable elongate handle with a working head at one end of the handle, the handle being assembled of at least a first length to which the working head is mounted and a second length that is coupled to the end of the first length remote from the working head, and which is adapted to be moved from a first position, in which the second length is stowed alongside or substantially coaxial with the first length but not obstructing the working head so that the utensil may be used, to a second position, in which the second length is substantially aligned with the first length to provide an extended overall handle length.

### FIELD OF THE INVENTION

The present invention concerns an improved handheld cleaning utensil of the type comprising a handle carrying a working head such as a sponge, brush or the like.

### BACKGROUND TO THE INVENTION

Handheld cleaning utensils comprising a handle with a brush, scouring sponge or other working head encompass such cleaning utensils as clothes brushes and sponges and scrubbing implements for cleaning dishes or work surfaces. Indeed, the present invention arose from observation of the difficulties arising in cleaning of domestic surfaces such as the bottom of a bath or shower tray and the tops of walls and shower cubicles using conventional hand held cleaning utensils.

To effectively reach remote areas of a bath or shower cubicle the handle of the utensil needs to be fairly lengthy. Conversely, for cleaning surfaces near to hand a shorter length handle is far more manageable. Currently there are no convenient hand held cleaning implements that satisfactorily adapt between having a short handle for cleaning close surfaces and a long handle that is strong enough for rigorously cleaning more remote surfaces. The lengthened handle needs to be rigid and robust and give good leverage and control, but the shortened handle needs to be compact and comfortable to hold.

Utensils such as mops and brushes that are configured for adjustment of handle length generally have telescopic handles, but these are generally either heavy and costly or do not have optimal rigidity when extended, deterring rigorous use and often the extended handles shift, bend or break. Whereas hinged collapsible handled toothbrushes and clothes brushes are known of—for example, U.S. Pat. No. 5,185,902 discloses a hinged folding handle pocket brush—these are adapted to fold shut for storage and do not provide for handle extension.

It is an objective of the present invention to address these shortcomings of existing hand held cleaning utensils.

### SUMMARY OF THE INVENTION

According to a first aspect of the present invention there is provided a hand held cleaning utensil having an extendable elongate handle with a working head at one end of the handle, the handle being assembled of at least a first length to which the working head is mounted and a second length that is coupled to the end of the first length remote from the working head, and which is adapted to be moved from a first position, in which the second length is stowed alongside or substantially coaxial with the first length but not obstructing the working head so that the utensil may be used, to a second position, in which the second length is substantially aligned with the first length to provide an extended overall handle length.

Preferably the second length is pivotally mounted to the first length, and particularly preferably the second length is pivotally mounted to the first length by an articulated pivot, the pivot being moveable whereby during alignment, or when aligned, one length may be moved longitudinally toward the other to bring the second length closer into cooperative engagement with the first length to provide a secure robust interconnection of the first and second lengths.

The second length suitably is configured to fold back against the first length to stow nested with the first length, substantially coaxially aligned with the first length, one length being at least partly accommodated within the other, whereby the user may comfortably grip the handle comprising the nested first and second lengths to operate the utensil.

Preferably where the second length is pivotally mounted to the first length the pivot comprises a pair of opposing axle stubs on one of the first and second handle lengths. Suitably, the axle stubs cooperate with a slot in the other of the first and second handle lengths. Particularly preferably, the axle stubs are adapted to cooperatively engage with a pivot component which bridges therebetween, in use. This bridging pivot component suitably serves to lock the second handle length to the first handle length and suitably is mounted in the slot to allow articulating movement of the moveable pivot.

In the preferred embodiment the bridging pivot component is an annulus. This may be initially separate from the first and second lengths of the handle. It is mounted in use in an aperture (suitably the aforementioned slot) of one of the first and second lengths of the handle and secured in place by bringing the axle stubs into cooperative engagement with it on each opposing side. Suitably the annulus is provided with a keyhole aperture shape on each opposing face, which is complementary to a corresponding key shape of the axle stubs to allow for cooperative engagement of the axle stubs in place on the bridging pivot component. Preferably the axle stubs are configured to snap fit into the bridging pivot component, having hook means to lock them in place.

Suitably the length of the handle having the aperture/slot to receive the bridging pivot component is further provided with ramp means to slightly splay the axle stubs and guide them into effective cooperative engagement with the bridging component.

Preferably the working head is demountably mounted to the first length of the handle, in use. It may comprise, for example, a scouring/cleaning pad or brush or the like. In one preferred embodiment the working head is demountable by sliding push fit of the said end of the first length of the handle into a socket in the working head.

The said end of the first handle length to which the working head fits may be angled relative to the remainder of the handle and suitably is provided with ribs or other protrusions to securely engage the working head.

The pivot bridging component in one preferred embodiment is integrally moulded with one of said first and second lengths of the handle, being linked to it by a frangible link.

### BRIEF DESCRIPTION OF THE DRAWINGS

A preferred embodiment of the present invention will now be more particularly described, by way of example, with reference to the accompanying drawings, wherein:

FIG. 1 is a perspective view of the preferred embodiment of the utensil showing the two handle lengths disassembled from each other and from the working head (cleaning pad) and pivot bridging component;

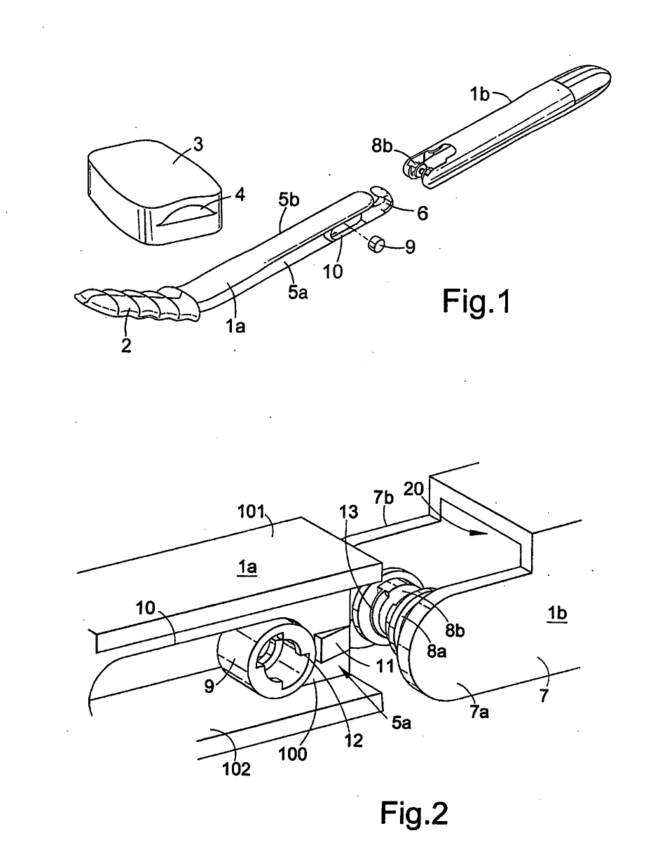

FIG. 2 is a close-up view of the cooperating ends of the respective handle lengths as they are brought together for coupling to each other in initial assembly of the utensil; and

FIGS. 3.1 to 3.5 are perspective views of the assembled utensil showing the utensil firstly in its compact/short handle length state and then the sequence of extension of the handle to the extended/long handle length state.

### DESCRIPTION OF THE PREFERRED EMBODIMENT

Referring to the figures, the illustrated hand held cleaning utensil comprises a two part handle 1 having a first length 1a, the front end portion of which is of relatively flattened profile, inclined upwardly and provided with ribs 2 in order to securely mount to it a separate working head 3, the working head 3 here being a cleaning foam pad 3. The cleaning foam pad 3 has a horizontal slit 4 across one end face and extending into the heart of the foam pad 3 The ribbed inclined front end of the first handle length la slidingly fits into this slit 4. The ribs 2 serve to resist dislodgement of the pad 3 from the handle 1 in usage but enable the pad 3 to be removed when needed to allow use of the cleaning pad 3 as a hand pad independently of the handle 1 or for replacement of the pad 3 with a new pad 3 or even a different working head 3.

Each of the first and second handle lengths 1a, 1b is a rigid and robust plastics moulding. The first length 1a is moulded to have a cross sectional shape of an I-beam for the majority of the extent of the first length 1a and suitably from at or close to the rear end of the first length 1a up to the point where the ribbed, inclined front end portion begins. This I-beam sectional shape of the first handle length 1a comprises a central ‘vertical’ wall 100 capped by top and bottom ‘horizontal’ walls 101, 102 along its extent and defining a pair of parallel recesses, 5a, 5b, each recess running along an opposing side of the first handle length 1a.

The second handle length 1b is moulded to have an arched cross sectional shape (aka ‘U’ section or ‘C’ section) having a channel 20 running for the majority of its extent. This enables the second length 1b of the handle to nest against the first length 1a accommodating it within the channel 20 when the two lengths 1a, 1b are coupled and folded together. The shape also makes the handle 1 strong and comfortable to grip, whether extended or folded.

Similarly, in the first handle length 1a, the recesses/channels 5a, 5b not only serve to optimise the strength to weight ratio in construction of the handle 1 but, at the rear end of the first handle length 1a, also act as channels for interlocking with fingers 7a, 7b of the second handle length 1b when the two handle lengths are coupled together and moved to the extended state.

The rear end of the first handle length 1a, furthermore, has an integral hanging hook 6. This hanging hook 6 may be used to hang up the cleaning implement for storage when the second handle length 1b is stowed folded down against the first handle length 1a.

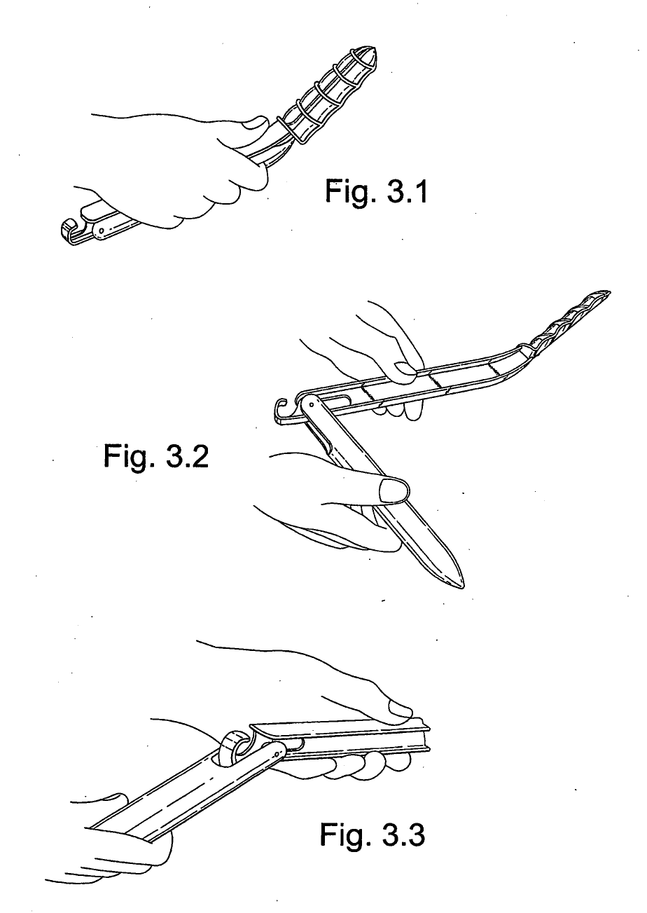

The coupling together of the first handle length 1a and second handle length 1b will now be described in more detail with reference to FIG. 2.

As can be seen clearly from FIG. 2, the front end of the second handle length 1b has the appearance of having a pair of forwardly extending parallel spaced apart fingers 7a, 7b as forward extensions of the side walls 7 of the second handle length 1b. These forwardly extending fingers 7a, 7b are, respectively, slidingly accommodated within the parallel opposing recesses 5a, 5b of the first handle length 1a whereby the second handle length 1b and first handle length 1a can be moved axially one along another so that they are axially aligned and inter-engaged with each other. The inter-digitation of the fingers 7a, 7b with the recesses 5a 5b makes the second handle length 1b perform as though it is integrally formed with the first handle length 1a, giving very good structural rigidity when the handle 1 is used in its extended state.

The second handle length 1b does not simply slidingly interlock with the first handle length 1a but rather is suitably permanently or semi-permanently pivotally coupled to it via a pair of opposing axle stubs 8a, 8b on the second handle length 1b. One axle stub 8a is provided on one finger 7a and the other stub 8b is provided on the other finger 7b, the two axle stubs facing each other across a short gap.

As initially manufactured, the first handle length 1a and second handle length 1b are separate components but they are permanently or semi-permanently coupled together by linking of the axle stubs 8a, 8b with an annular pivot bridging component 9. The annular bridging component 9 is positioned at the rear end of the first handle length 1a, situated within an elongate slot 10 through the central wall 100 of the first handle length 1a. The slot 10 extends from close to the rear end of the first handle length 1a for a short distance forwardly along the first handle length 1a.

The pivot bridging component 9 may initially be completely separate from the first handle length 1a or may be integrally formed or assembled with it, suitably being integrally moulded with the first handle length 1a and linked to it by a small frangible bridging section. Integral formation of the annular bridging component 9 with the first handle length 1a may enhance cost economy, removing the need for a separate hinge pin, and facilitates initial assembly of the two handle lengths 1a, 1b. Furthermore, unlike the use of an integral hinge pin without a break in the middle, the modular construction of the pivot comprising the opposing pivot stubs 8a, 8b and the interlinking bridging component 9 avoids the need for a break in the rear of the first handle length 1a which would otherwise weaken the handle at that region.

When initially assembling the second handle length 1b to the first handle length 1a, the opposing pivot stubs 8a, 8b on the fingers 7a, 7b of the second handle length 1b pass to either side of the central wall 100 of the first handle length 1a, and are guided apart by a short ramp surface 11 on each face of the central wall 100 to guide the axle stubs 8a, 8b into engagement with keyhole apertures 12 on each opposing face of the annular pivot bridging component 9. Each of the fingers 7a, 7b resiliently snap inwardly toward each other forcing the axle stubs 8a, 8b into engagement with the apertures 12 in the opposing faces of the pivot bridging component 9 and the axle stubs 8a, 8b are firmly held in place by flanges 13 on the axle stubs 8a, 8b which hook within the bridging component 9 behind the rim of the keyhole aperture 12.

Where the bridging component 9 is initially frangibly connected to the central wall 100 of the first handle length 1a, an initial push on the second handle length 1b during extension of the handle 1 will snap the frangible attachment leaving the bridging component 9 to ride along the length of the slot 10.

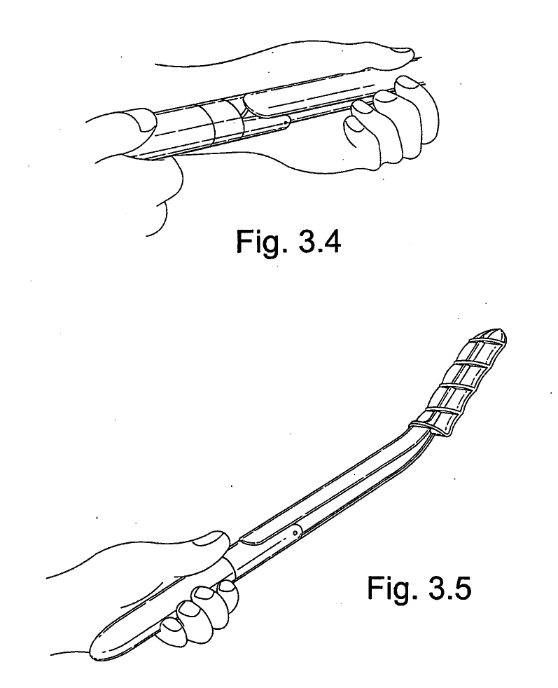

Referring to FIGS. 3.1 to 3.5, these illustrate the sequence of extension of the handle 1 of the utensil from the initial compact handle length state (FIG. 3.1) through to the fully extended handle length state (FIG. 3.5).

As can be seen from FIG. 3.1, in the compact state of the handle 1 the first length 1a of the handle is neatly accommodated within the channel 20 of the second length 1b of the handle whereby the user grips the handle 1 with his fingers wrapped around the sidewall 7 and rear wall of the second handle length 1b and suitably with his/her thumb pressed down against the exposed upper wall 101 of the first handle length 1a. As can also been seen in this view, the hook 6 is freely exposed to enable it to be used to hang up the implement for storage.

Turning to FIG. 3.2, this shows the user unfolding the second handle length 1b from the first handle length 1a by pivoting it rearwardly away from the first handle length 1a about the pivot pin 8, 9. This progresses through the position shown in FIG. 5.3 to the position shown in FIG. 5.4 where the second handle length 1b and first handle length 1a are substantially coaxially aligned, at which point the fingers 7a, 7b of the second handle length 1b are aligned with the lateral recesses 5a, 5b of the first handle length 1a and the user then simply pushes the second handle length 1b forwardly into closer cooperative engagement with the rear end of the first handle length 1a so that the fingers 7a, 7b slide along and thereby firmly inter engage with the recesses 5a, 5b.

As will be appreciated, the pivot 8,9 is generally positioned toward the rear end of the slot 10 on the first handle length 1a when the second handle length 1b is stowed against the first handle length 1a and remains in that position until the second handle length 1b has been pivoted into substantial alignment with the first handle length 1a to enable it to then be pushed forwardly, moving the pivot 8,9 along the slot 10 and simultaneously moving the fingers 7a, 7b into tighter engagement with the recesses 5a, 5b. In this extended securely engaged position the two handle lengths 1a, 1b form a continuous rigid handle of substantially increased length and which can be readily used with comfort to carry out vigorous cleaning of less accessible areas to be cleaned.

1. A hand held cleaning utensil having an extendable elongate handle with a working head at one end of the handle, the handle being assembled of at least a first length to which the working head is mounted and a second length that is coupled to the end of the first length remote from the working head, and which is adapted to be moved from a first position, in which the second length is stowed alongside or substantially coaxial with the first length but not obstructing the working head so that the utensil may be used, to a second position, in which the second length is substantially aligned with the first length to provide an extended overall handle length, wherein the second length is pivotally mounted to the first length by an articulated pivot, the pivot being slidingly moveable whereby during alignment, or when aligned, one length may be moved longitudinally toward the other to bring the second length closer into cooperative engagement with the first length to provide a secure robust interconnection of the first and second lengths:

2-3. (canceled)

4. A hand held cleaning utensil as claimed in claim 1, wherein the second length is configured to fold back against the first length to stow nested with the first length, substantially coaxially aligned with the first length, one length being at least partly accommodated within the other, whereby the user may comfortably grip the handle comprising the nested first and second lengths to operate the utensil.

5. A hand held cleaning utensil as claimed in claim 1, wherein the pivot comprises a pair of opposing axle stubs on one of the handle lengths.

6. A hand held cleaning utensil as claimed in claim 5, wherein the axle stubs cooperate with a slot in the other of the handle lengths.

7. A hand held cleaning utensil as claimed in claim 6, wherein the axle stubs are adapted to cooperatively engage with a pivot component which bridges therebetween, in use.

8. A hand held cleaning utensil as claimed in claim 7, wherein the bridging pivot component serves to lock the second handle length to the first handle length and is mounted in the slot to allow articulating movement of the moveable pivot.

9. A hand held cleaning utensil as claimed in claim 7, wherein the bridging pivot component is an annulus.

10. A hand held cleaning utensil as claimed in claim 7, wherein the bridging pivot component has a keyhole aperture shape on each opposing face, which is complementary to a corresponding key shape of the axle stubs for cooperative engagement of the axle stubs with the bridging pivot component.

11. A hand held cleaning utensil as claimed in claim 7, wherein the axle stubs are configured to snap fit into the bridging pivot component, having hook means to lock them in place.

12. A hand held cleaning utensil as claimed in claim 7, wherein the length of the handle having the slot to receive the bridging pivot component has ramp means to slightly splay the axle stubs and guide them into effective cooperative engagement with the bridging component.

13. A hand held cleaning utensil as claimed in claim 7, wherein the pivot bridging component is integrally molded with one of said first and second lengths of the handle, being linked to it by a frangible link.

14. A hand held cleaning utensil as claimed in claim 1, wherein the working head is releasably mounted to the first length of the handle, in use.

15. A hand held cleaning utensil as claimed in claim 8, wherein the bridging pivot component has a keyhole aperture shape on each opposing face, which is complementary to a corresponding key shape of the axle stubs for cooperative engagement of the axle stubs with the bridging pivot component.

16. A hand held cleaning utensil as claimed in claim 8, wherein the axle stubs are configured to snap fit into the bridging pivot component, having hook means to lock them in place.

17. A hand held cleaning utensil as claimed in claim 8, wherein the length of the handle having the slot to receive the bridging pivot component has ramp means to slightly splay the axle stubs and guide them into effective cooperative engagement with the bridging component.

18. A hand held cleaning utensil as claimed in claim 8 wherein the pivot bridging component is integrally molded with one of said first and second lengths of the handle, being linked to it by a frangible link.

19. A hand held cleaning utensil as claimed in claim 4, wherein the working head is releasably mounted to the first length of the handle, in use.

20. A hand held cleaning utensil as claimed in claim 5, wherein the working head is releasably mounted to the first length of the handle, in use.
